(19) United States
(12) Patent Application Publication
(10) Pub. No.: US 2009/0043905 A1
(43) Pub. Date: Feb. 12, 2009

(54) Portable terminal and data output control system

(75) Inventors: Mikio Aoki, Suwa-shi (JP); Shinya Taniguchi, Suwa-shi (JP); Joji Onishi, Tsukuba-shi (JP)

Correspondence Address: OLIFF & BERRIDGE, PLC, P.O. BOX 320850, ALEXANDRIA, VA, 22320-4850, US

(73) Assignee: SEIKO EPSON CORPORATION, Tokyo (JP)

(21) Appl. No.: 12/232,713

(22) Filed: Sep. 23, 2008

Related U.S. Application Data
(63) Continuation of application No. 09/949,666, filed on Sep. 12, 2001.
Application No. 09/949,666 is a continuation of application No. PCT/JP01/00173, filed on Jan. 12, 2001.

(30) Foreign Application Priority Data
Jan. 12, 2000 (JP) 2000-003931

(51) Int. Cl. G06F 15/16

(52) U.S. Cl. 709/230

(57) ABSTRACT

The present invention provides a portable terminal and data output control system suitably used for readily obtaining detailed information on a network. The invention can include a data output control terminal communicably connects a user-owned portable terminal, printing devices situated at various locations, and WWW servers, via the Internet. Data printing requests can be received from the portable terminal, data relating to the data printing request can be obtained from a WWW server, one of the printing devices is selected, and the obtained data is output to the selected printing device. The portable terminal can obtain data from the WWW server, display the obtained data on an LCD and append a data printing request item at the end of the display data for display on the LCD, and in the event that the displayed data printing request item is selected, sends a data printing request to the data output control terminal.

This is a Continuation of application Ser. No. 09/949,666 filed Sep. 12, 2001, which in turn is a Continuation of PCT/JP01/00173, filed Jan. 12, 2001, which in turn claims the benefit of Japanese Patent Application No. 2000-003931, filed Jan. 12, 2000. The entire disclosures of the prior applications are hereby incorporated by reference herein in their entirety.

### BACKGROUND OF THE INVENTION

1. Field of Invention

The present invention relates to a system and terminal for communicably connecting a user-owned portable terminal and multiple printing devices situated at various localities via a network, receiving data printing requests from the portable terminal, and outputting data relating to the data printing requests to one of the printing devices. The present invention particularly relates to a portable terminal and data output control system suitably used for readily obtaining detailed information on a network.

2. Description of Related Art

In recent years, information on the Internet can be readily obtained at any location by using i-Mode™ provided by NTT DoCoMo, Inc., for example. However, with such portable terminals, while information on the Internet can be readily obtained at any location, the display capabilities are usually of a simple configuration due to considerations as to reduction in size of the portable terminal and reduction in power consumption and so forth. Therefore, so that the information displayed is quite simplified as compared to that displayed on a normal personal computer. Such portable terminals generally do not provide display capabilities which sufficiently satisfies the users.

Accordingly, to obtain detailed information while maintaining the small size and reduction in power consumption of the portable terminals, a proposal can be made for an arrangement of combining a portable terminal with a printing device, so as to display general information on the portable terminal and print detailed information with the printing device. However, there are several problems which must be technically solved for such an arrangement combining a portable terminal with a printing device.

For example, a printing device can be large and not readily carried along with a portable terminal, so printing detailed information using a printing device set up in the home or office can be conceived. However, using such a fixed particular printing device does not guarantee that information can readily be obtained at any location. Accordingly, in order to realize portable printing there is the need to either reduce the printing device to a portable level, or to arrange for arbitrary printer devices to be used. In the case of the former, it is extremely difficult to technologically realize this at the current state, so this is not realistic. In the case of the latter, unique drivers are necessary for each printing device, so drivers for all printing devices to be used must be installed in the portable terminal, which also is not realistic.

### SUMMARY OF THE INVENTION

Accordingly, the present invention has been made in light of such unsolved problems, and it is an object thereof to provide a portable terminal and data output control system suitably used for readily obtaining detailed information on a network.

In order to achieve the above objects, the present invention provides a portable terminal and a data output control system. FIG. 1 is a conceptual diagram illustrating the configuration of the portable terminal and the data output control system.

As shown in FIG. 1, with the portable terminal 20 that uses a data output control device 10 which communicably connects a user-owned portable terminal 20 which is portable and sends output requests for data, a plurality of output terminals 15 situated at various locations for outputting data, and a data storing terminal 16 storing data, via a network. The data output control device 10 can include an obtaining device for obtaining data relating to the data output requests from the data storing terminal 16, a selecting device for selecting one of the plurality of output terminals 15, and an output device for outputting data obtained by the obtaining device 11 to an output terminal 15 selected by the selecting device 12. The portable terminal 20 can include a terminal-side obtaining device 21 for obtaining data from the data storing terminal 16, display device 22 for displaying data obtained by the terminal-side obtaining device 21, an input device 23 for inputting output requests for data displayed by the display device 22, and data output request originating device 24 for sending data output requests input by the input device 23 to the data output control device 10.

According to such a configuration, with the portable terminal 20, data is obtained from the data storing terminal 16 by the terminal-side obtaining device 21, and the obtained data is displayed by the display device 22. Then, in the event that the output request for the displayed data is input from the input device 23, the input data output request is sent to the data output control device 10 by the data output request originating device 24.

At the data output control device 10, upon receiving the data output request from the portable terminal 20, data relating to the data output request is obtained from the data storing terminal 16 by the obtaining device 11, one of the plurality of output terminals 15 is selected by the selecting device 12, and the obtained data is output to the selected output terminal 15 by the output device 13. Then, the data is output by the output terminal 15.

Now, the selecting device 12 may be of any configuration so long as one of the plurality of output terminals 15 is selected, but specifically is arranged so as to select an output terminal 15 which is considered to be optimal for the user of the portable terminal 20 to receive the output data from. In this case, examples of an output terminal 15 which is considered to be optimal for the user of the portable terminal 20 to receive the output data from include an output terminal 15 which is considered to be the closest distance-wise or time-wise based on the position of the portable terminal 20, an output terminal 15 which is considered to be the closest distance-wise or time-wise with the target location of the user of the portable terminal 20 as a reference, an output terminal 15 which is considered to be able to provide the user with the output data the fastest taking into consideration the data output speed of the output terminal 15, or an output terminal 15 with the most inexpensive price for providing the output data.

Also, the output terminal 15 may be of any configuration so long as data is output, including for example display device for displaying data, audio output device for outputting data as audio or the like, or printing device for printing data.

Further, as shown in FIG. 1, according to the portable terminal 20 of the present invention, input items for prompting input to the input device 23 are displayed on the display device 22 along with data obtained by the terminal-side obtaining device 21, and the data output request originating device 24 sends output requests for data displayed by the display device 22 to the data output control device 10, in the event that the input items are selected as input by the input device 23.

According to such a configuration, with the portable terminal 20, the obtained data is displayed by the display device 22, and input items for prompting input to the input device 23 are displayed along with the obtained data. Once the input items are selected, an output request for the displayed data is sent to the data output control device 10 by the data output request originating device 24.

Further, as shown in FIG. 1, according to the portable terminal 20 of the present invention, input items for prompting input to the input device 23 are displayed on the display device 22 as menu items separate from the data obtained by the terminal-side obtaining device 21, and the data output request originating device 24 sends output requests for data displayed by the display device 22 to the data output control device 10, in the event that the input items are selected as input by the input device 23.

According to such a configuration, with the portable terminal 20, obtained data is displayed by the display device 22, and input items for prompting input to the input device 23 are displayed as menu items. Once the input items are selected, an output request for the displayed data is sent to the data output control device 10 by the data output request originating device 24.

Further, as shown in FIG. 1, according to the portable terminal 20 of the present invention, an input button for inputting data output requests is provided as the input device 23.

According to such a configuration, with the portable terminal 20, upon pressing the input button the output request of data displayed is sent to the data output control device 10.

Further, as shown in FIG. 1, with the portable terminal 20 of the present invention which uses a data output control device 10, which communicably connects a user-owned portable terminal 20 which is portable and sends output requests for data and a plurality of output terminals 15 situated at various locations for outputting data via a network, the data output control device 10 can include a selecting device 12 for selecting one of the plurality of output terminals 15, and output device 13 for outputting data relating to the data output request to an output terminal 15 selected by the selecting device 12. The portable terminal can further include a plurality of communicating devices 25 for performing communication with the data output control device 10 with different communication methods, a communication path selecting device 26 for selecting from the plurality of communicating devices 25 a communicating device 25 which is currently communicable with the data output control device 10, and a data output request originating device 24 for sending the data output requests to the data output control device 10 with the communication device 25 selected by the communication path selecting device 26.

According to such a configuration, with the portable terminal 20, a communication device 25 currently capable of communication with the data output control device 10 is selected from the plurality of communication devices 25 by the communication path selecting device 26, and the data output request is sent to the data output control device 10 with the selected communication device 25 by the data output request originating device 24.

With the data output control device 10, upon receiving a data output request from the portable terminal 20, one of the plurality of output terminals 15 is selected by the selecting device 12, and data relating to the data output request is output to the selected output terminal 15 by the output device 13. Then, the data is output by the output terminal 15.

Now, the data relating to the data output request may be, for example, received from the portable terminal 20, or may be obtained from somewhere else than the data output control device 10 and portable terminal 20. In the case of the latter, more specifically, the following configuration can be given. That is, the data output control device 10 further can include an obtaining device 11 for communicably connecting via network to the data storing terminal 16 for storing data and obtaining data relating to the data output requests from the data storing terminal 16, with the output device 13 arranged so as to output the data obtained by the obtaining device 11 to the output terminal 15 selected by the selecting device 12.

According to such a configuration, with the data output control device 10, upon receiving a data output request from the portable terminal 20, data relating to the data output request is obtained from the data storing terminal 16 by the obtaining device 11, and the obtained data is output to the output terminal 15 selected by the selecting device 12, by the output device 13.

Further, as shown in FIG. 1, according to the portable terminal 20 of the present invention, the communication path selecting device 26 and the data output request originating device 24 send the data output request to the data output control device 10 by one of the plurality of communication devices 25, and in the event that communication with the data output control device 10 fails, send the data output request to the data output control device 10 by another of the plurality of communication devices 25.

According to such a configuration, with the portable terminal 20, a data output request is sent to the data output control device 10 by one communication devices 25 of the plurality of communication devices 25 by the communication path selecting device 26 and the data output request originating device 24, and in the event that communication with the data output control device 10 fails, the data output request is sent to the data output control device 10 by another communication device 25 of the plurality of communication devices 25.

Further, as shown in FIG. 1, according to the portable terminal 20 of the present invention, can include at least one of a long-distance wireless LAN (Local-Area Network) and a short-distance wireless LAN as the communication device 25.

According to such a configuration, with the portable terminal 20, upon the long-distance wireless LAN or short-distance wireless LAN being selected by the communication path selecting device 26 as the communication device 25, the data output request is sent to the data output control device 10 by the long-distance wireless LAN or short-distance wireless LAN with the data output request originating device 24.

Further, as shown in FIG. 1, with the portable terminal 20 of the present invention which communicably connects a user-owned portable terminal 20 which is portable and sends output requests for data, a plurality of output terminals 15 situated at various locations for outputting data, and a plurality of data storing terminals 16 storing data, via a network, the data output control device 10 includes a obtaining device 11 for obtaining data relating to the data output requests from a data storing terminal 16 determined by output object storage position data for determining the storage position of data with the data storing terminal 16 contained in the data output request a selecting device 12 for selecting one of the plurality of output terminals 15, and an output device 13 for outputting data obtained by the obtaining device 11 to an output terminal 15 selected by the selecting device 12. The portable terminal can further include a terminal-side obtaining device 21 for obtaining data from the data storing terminal 16, display device 22 for displaying data obtained by the terminal-side obtaining device 21, and a data output request originating device 24 for sending to the data output control device 10 a data output request containing only the output object storage position data for determining the storage position of data at the data storing terminal 16 obtained by the terminal-side obtaining device 21.

According to such a configuration, with the portable terminal 20, data is obtained from the data storing terminal 16 by the terminal-side obtaining device 21 and the obtained data is displayed by the display device 22. Then, data output requests containing only output object storage position data is sent to the data output control device 10 by the data output originating device.

With the data output control device 10, upon receiving a data output request from the portable terminal 20, data relating to the data output request is obtained by the obtaining device 11 from the data storing terminal 16 specified by the output object storage position data contained in the data output request, one of the plurality of output terminals 15 is selected by the selecting device 12, and the obtained data is output to the selected output terminal 15 by the output device 13. Then, the data is output from the output terminal 15.

Further, as shown in FIG. 1, with the portable terminal 20 of the present invention which uses a data output control device 10 which communicably connects a user-owned portable terminal 20 which is portable and sends printing requests for data, and a plurality of output terminals 15 situated at various locations for printing data, via a network, the data output control device 10 includes a selecting device 12 for selecting one of the plurality of output terminals 15, image data generating device 14 for generating conceptual image data displayable by the portable terminal 20 which is a conceptual image in the event that data relating to the data printing request is printed by an output terminal 15 selected by the selecting device 12, and an output device 13 for outputting data relating to the data printing requests to an output terminal 15 selected by the selecting device 12. The output device 13 outputs conceptual image data generated by the image data generating device 14 to the portable terminal 20, and in the event of receiving a data printing execution request from the portable terminal 20 as a response to the output of the conceptual image data, the data relating to the data printing request is output to the output terminal 15 selected by the selecting device 12. The portable terminal can further include data printing request originating device 24 for sending the data printing requests to the data output control device 10, display device 22 for displaying conceptual image data from the data output control device 10, an input device 27 for inputting specification of a part regarding which printing is desired in the event that the conceptual image data displayed on the displaying device 22 consists of a plurality of sets of data, and a data printing execution request originating device 28 for sending the data printing execution request to the data output control device 10. The data printing execution request originating device 28 sends to the data output control device 10 a data printing execution request containing a request for printing a specified part input with the input device 27 in the event that there has been input with the input device 27.

According to such a configuration, with the portable terminal 20, a data printing request is output to the data output control device 10 by the data printing request originating device 24.

With the data output control device 10, upon receiving a data printing request from the portable terminal 20, one is selected by the printing device from the plurality of output terminals 15, conceptual image data which is a conceptual image of data relating to a dating printing request at the time of being printed at the selected output terminal 15 is generated by the image data generating device 14, and the generated conceptual image data is output to the portable terminal 20 by the output device 13.

With the portable terminal 20, upon receiving conceptual image data from the data output control device 10, the conceptual image data is displayed by the display device 22. At this time, in the event that the conceptual image data displayed consists of a plurality of sets of data, and there is input of specification of a part regarding which printing is desired from the input device 27, the data printing execution request originating device 28 sends a data printing execution request containing a request for printing the specified part, to the data output control device 10.

At the data output control device 10, upon receiving the data printing execution request from the portable terminal 20, the output device 13 outputs the data relating to the data printing request to the output terminal 15 selected by the selecting device 12. Then, the data is printed by the output terminal 15.

Now, the data relating to the data printing request may be, for example, received from the portable terminal 20, or my be obtained from somewhere else than the data output control device 10 and portable terminal 20. In the case of the latter, more specifically, the following configuration can be given. That is, the data output control device 10 further includes an obtaining device 11 for communicably connecting via network to the data storing terminal 16 for storing data and obtaining data relating to the data printing requests from the data storing terminal 16, with the output device 13 arranged so as to output the data obtained by the obtaining device 11 to the output terminal 15 selected by the selecting device 12.

According to such a configuration, with the data output control device 10, upon receiving a data printing request from the portable terminal 20, data relating to the data printing request is obtained from the data storing terminal 16 by the obtaining device 11, and the obtained data is output to the output terminal 15 selected by the selecting device 12, by the output device 13.

On the other hand, as shown in FIG. 1, the data output control system of the present invention is a system that includes a user-owned portable terminal 20 which is portable and sends output requests for data, and a data output control device 10 which receives data output requests from the portable terminal 20 and performs output control of data relating to the data output requests, the data output control device 10 communicably connecting the portable terminal 20, a plurality of output terminals 15 situated at various locations for outputting data, and a data storing terminal 16 storing data, via a network. The data output control device 10 can include an obtaining device 11 for obtaining data relating to the data output requests from the data storing terminal 16, a selecting device 12 for selecting one of the plurality of output terminals 15, and output device 13 for outputting data obtained by the obtaining device 11 to an output terminal 15 selected by the selecting device 12. The portable terminal 20 can include a terminal-side obtaining device 21 for obtaining data from the data storing terminal 16, a display device 22 for displaying data obtained by the terminal-side obtaining device 21, an input device 23 for inputting output requests for data displayed by the display device 22, and data output request originating device 24 for sending data output requests input by the input device 23 to the data output control device 10.

Further, as shown in FIG. 1, according to the data output control system of the present invention, the portable terminal 20 displays input items for prompting input to the input device 23 on the display device 22 along with data obtained by the terminal-side obtaining device 21, and the data output request originating device 24 sends output requests for data displayed by the display device 22 to the data output control device 10, in the event that the input items are selected as input by the input device 23.

Further, as shown in FIG. 1, according to the data output control system of the present invention, the portable terminal 20 displays input items for prompting input to the input device 23 on the display device 22 as menu items separate from the data obtained by the terminal-side obtaining device 21, and the data output request originating device 24 sends output requests for data displayed by the display device 22 to the data output control device 10, in the event that the input items are selected as input by the input device 23.

Further, as shown in FIG. 1, according to the data output control system of the present invention, the portable terminal 20 includes an input button for inputting data output requests as the input device 23.

Further, as shown in FIG. 1, the data output control system according to the present invention is configured including a user-owned portable terminal 20 which is portable and sends output requests for data, and a data output control device 10 which receives data output requests from the portable terminal 20 and performs output control of data relating to the data output requests. The data output control device 10 communicably connecting the portable terminal 20 and a plurality of output terminals 15 situated at various locations for outputting data, via a network. The data output control device 10 can include a selecting device 12 for selecting one of the plurality of output terminals 15, and an output device 13 for outputting data relating to the data output request to an output terminal 15 selected by the selecting device 12. The portable terminal 20 includes: a plurality of communicating devices 25 for performing communication with the data output control device 10 with different communication methods, a communication path selecting device 26 for selecting from the plurality of communicating devices 25 a communicating device 25 which is currently communicable with the data output control device 10, and an data output request originating device 24 for sending the data output requests to the data output control device 10 with the communication device 25 selected by the communication path selecting device 26.

Further, as shown in FIG. 1, according to the data output control system of the present invention, the communication path selecting device 26 and the data output request originating device 24 send the data output request to the data output control device 10 by one of the multiple communication devices 25, and in the event that communication with the data output control device 10 fails, send the data output request to the data output control device 10 by another of the multiple communication devices 25.

Further, as shown in FIG. 1, according to the data output control system of the present invention, the portable terminal 20 includes at least one of a long-distance wireless LAN (Local-Area Network) and a short-distance wireless LAN as the communication device 25.

Further, as shown in FIG. 1, the data output control system according to the present invention is configured including a user-owned portable terminal 20 which is portable and sends output requests for data, and a data output control device 10 which receives data output requests from the portable terminal 20 and performs output control of data relating to the data output requests. The data output control device 10 communicably connecting the portable terminal 20, a plurality of output terminals 15 situated at various locations for outputting data, and a plurality of data storing terminals 16 storing data, via a network. The data output control device 10 can include an obtaining device 11 for obtaining data relating to the data output requests from a data storing terminal 16 determined by output object storage position data for determining the storage position of data with the data storing terminal 16 contained in the data output request, a selecting device 12 for selecting one of the plurality of output terminals 15, and output device 13 for outputting data obtained by the obtaining device 11 to an output terminal 15 selected by the selecting device 12, The portable terminal 20 can include a terminal-side obtaining device 21 for obtaining data from the data storing terminal 16. a display device 22 for displaying data obtained by the terminal-side obtaining device 21, and a data output request originating device 24 for sending to the data output control device 10 a data output request containing only the output object storage position data for determining the storage position of data at the data storing terminal 16 obtained by the terminal-side obtaining device 21.

Further, as shown in FIG. 1, the data output control system of the present invention is configured including a user-owned portable terminal 20 which is portable and sends output requests for data, and a data output control device 10 which receives data output requests from the portable terminal 20 and performs output control of data relating to the data output requests; the data output control device 10 communicably connecting a portable terminal 20 and a plurality of output terminals 15 situated at various locations for printing data, via a network. The data output control device 10 can include a selecting device 12 for selecting one of the plurality of output terminals 15, an image data generating device 14 for generating conceptual image data displayable by the portable terminal 20 which is a conceptual image in the event that data relating to the data printing request is printed by an output terminal 15 selected by the selecting device 12, and an output device 13 for outputting data relating to the data printing requests to an output terminal 15 selected by the selecting device 12. The output device 13 outputs to the portable terminal 20 conceptual image data generated by the image data generating device 14, and in the event of receiving a data printing execution request from the portable terminal 20 as a response to the output of the conceptual image data, the data relating to the data printing request is output to the output terminal 15 selected by the selecting device 12. The portable terminal 20 can include a data printing request originating device 24 for sending the data printing requests to the data output control device 10, a display device 22 for displaying conceptual image data from the data output control device 10 an input device 27 for inputting specification of a part regarding which printing is desired in the event that the conceptual image data displayed on the displaying device 22 consists of a plurality of sets of data, and a data printing execution request originating device 28 for sending the data printing execution request to the data output control device 10. The data printing execution request originating device 28 sends to the data output control device 10 a data printing execution request containing a request for printing a specified part input with the input device 27 in the event that there has been input with the input device 27.

### BRIEF DESCRIPTION OF THE DRAWINGS

The invention is described in detail with reference to the following figures, wherein like numerals reference like elements, and wherein:

FIG. 1 is a conceptual diagram illustrating the configuration of the portable terminal and the data output control system according to the present invention;

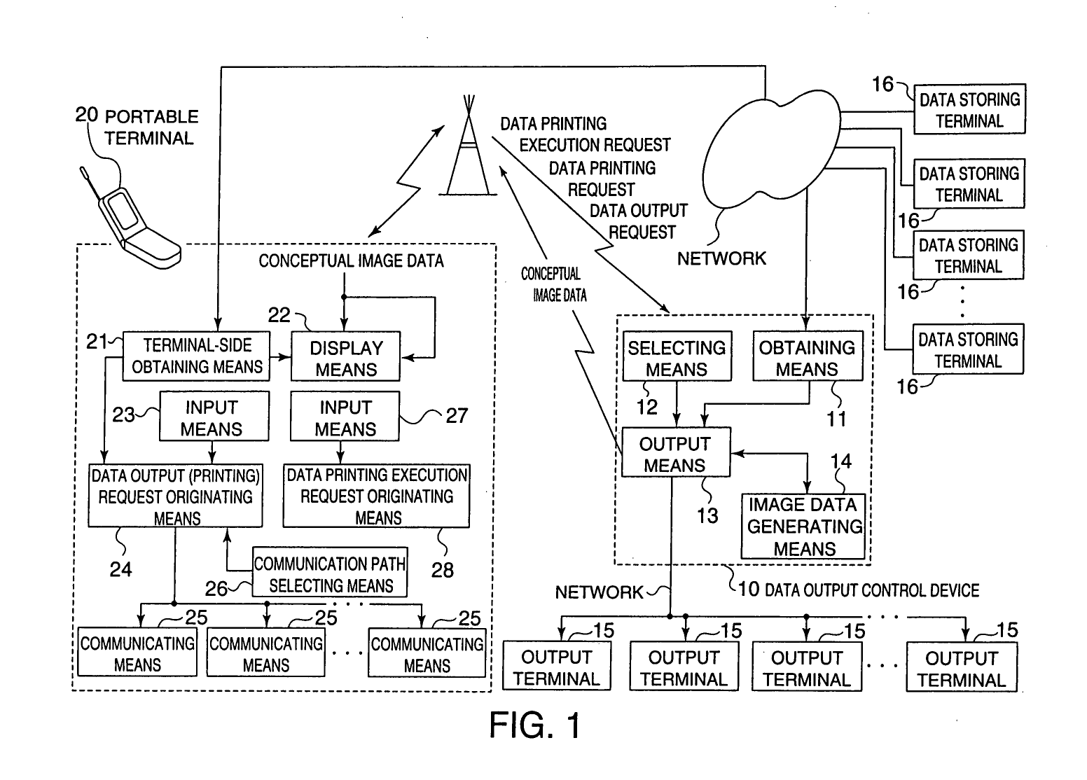

FIG. 2 is a block diagram illustrating the configuration of a network system to which the portable terminal and data output control system according to the present invention are applied;

FIG. 3 is a block diagram illustrating the configuration of a portable terminal 100;

FIG. 4 is a flowchart illustrating data printing request processing;

FIG. 5 is a block diagram illustrating the configuration of a data output control terminal 300; and

FIG. 6 is a flowchart illustrating data output control processing.

### DETAILED DESCRIPTION OF PREFERRED EMBODIMENTS

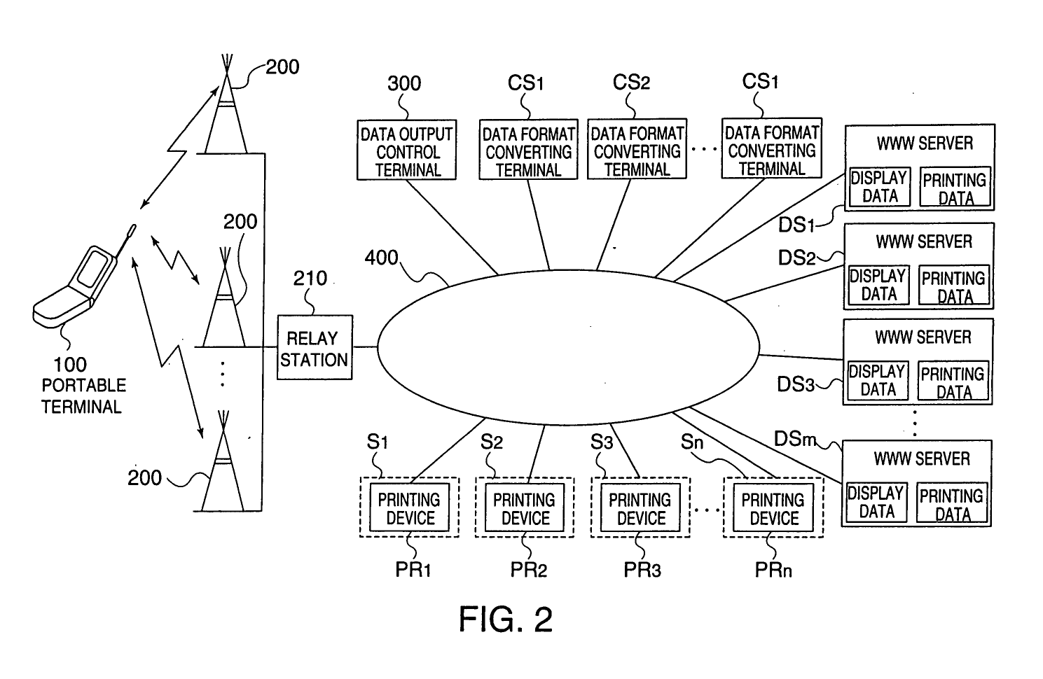

The following is a description of embodiments of the present invention, with reference to the drawings. FIG. 2 through FIG. 6 are diagrams illustrating an embodiment of a portable terminal and data output control system according to the present invention.

FIG. 2 shows an exemplary block diagram of a portable terminal and data output control system according to the present invention applied to a service, wherein a service provider, in accordance with printing requests for data from users, obtains data relating to the data printing request from one of WWW (World Wide Web) servers DS₁ through DSₘ and outputs this to one of printing devices PR₁ through PRₙ, with a data output control terminal 300 which communicably connects a portable terminal 100 such as a cellular phone or the like which a user owns, and printing devices PR₁ through PRₙ each installed in a plurality of locally-situated shops S₁ through Sₙ, via the Internet 400. While only one portable terminal 100 is shown in order to facilitate understanding of the invention, it is to be understood that in reality a plurality of different models of portable terminals 100 can be connected to the Internet 400.

First, the configuration of the network system to which the portable terminal and data output control system according to the present invention is applied will be described with reference to FIG. 2. FIG. 2 is a block diagram illustrating the configuration of the network system to which the portable terminal and data output control system according to the present invention are applied.

As shown in FIG. 2, connected to the Internet 400 are a relay station 210 for relaying communications between the portable terminal 100 and the Internet 400, printing devices PR₁ through PRₙ for printing data, WWW servers DS₁ through DSₘ for storing data, a data output control terminal 300 for obtaining data relating to a data printing request from one of the WWW servers DS₁ through DSₘ and outputting to one of the printing devices PR₁ through PRₙ, and data format converting terminals CS, through CS, for converting the data obtained by the data output control terminal 300 into data which can be printed by the printing devices PR₁ through PRₙ.

Multiple base stations 200 which perform wireless communication with the portable terminal 100 are connected to the relay station 210, so in the event that the portable terminal 100 is to connect to the Internet 400, the relay station 210 serves as a terminal on the Internet 400 instead of the portable terminal 100, transmitting data received from the portable terminal 100 via a base station 200 to a target terminal via the Internet 400, and also transmitting data of the target terminal on the Internet 400 to the portable terminal 100 via the base station 200. The portable terminal 100 can simultaneously communicates with at least three base stations 200, the relay station 210 measures the time difference in the time from the airwaves from the portable terminal 100 to reach the base stations 200 and measures the position of the portable terminal 100 based on the measured time difference.

The WWW servers DS₁ through DSₘ can include a storing unit for storing display data for displaying with the portable terminal 100 and printing data for printing with the printing devices PR₁ through PRₙ corresponding to the display data, and a request processing unit for transmitting data in the storing unit to terminals such as the relay station 210 and data output control terminal 300 connected to the Internet 400 according to requests from the terminals.

The request processing unit is a function realized by an unshown CPU executing programs stored in an external storage device or the like, and transmits display data or printing data in the storage unit in the event that there is a data transmitting request from an external terminal (portable terminal 100, data output control terminal 300, etc.). Whether to transmit display data or printing data is judged by the URL contained in the data transmission request. The storing unit stores, as printing data, various files such as text data, still image data, sound data, moving picture data such as MPEG, 3-D image data such as VRML, program data such as JAVA and so forth, and HTML (HyperText Markup Language) files.

The data format converting terminals CS₁ through CS₁ are terminals for executing data format conversion processing for converting the data obtained by the data output control terminal 300 into data which can be printed by the printing devices PR₁ through PRₙ, so that one or multiple data format converting terminals CS₁ through CS₁ are selected according to the sending load of the Internet 400 or the processing load of the data format converting terminals CS, and data format conversion processing is executed with the selected data format converting terminal CS. Specifically, one or multiple data format converting terminals CS₁ through CS₁ necessary for the data format conversion processing are selected in order of smaller sending load of the Internet 400 or processing load of the data format converting terminal CS.

The data format converting terminal CS whereby the data format converting processing is executed receives a data format conversion request and data to be converted from the data output control terminal 300, converts, of the data obtained by the data output control terminal 300, that data of a predetermined format into data which can be printed by corresponding printing devices PR₁ through PRₙ by data format conversion processing, and transmits the converted data to the data output control terminal 300.

For example, in the event that format conversion processing is being executed with the data format converting terminals CS₁ through CS₃, this would be carried out in the manner of the data format converting terminal CS₁ converting data of a predetermined format A (e.g., HTML format) of the data obtained by the data output control terminal 300 into data which can be printed by the printing devices PR₁ through PR₅, the data format converting terminal CS₂ converting data of a predetermined format B (e.g., JPEG format) of the data obtained by the data output control terminal 300 into data which can be printed by the printing devices PR₆ through PR₁₀, and the data format converting terminal CS₃ converting data of a predetermined format C (e.g., WORD (Registered Trademark) document format) of the data obtained by the data output control terminal 300 into data which can be printed by the printing devices PR₁₁ through PR₁₅. In this case, the printing devices PR₁ through PR₅ apparently serve as devices for printing the data of the predetermined data format A in a dedicated manner, the printing devices PR₆ through PR₁₀ as devices for printing the data of the predetermined data format B in a dedicated manner, and the printing devices PR₁₁ through PR₁₅ as devices for printing the data of the predetermined data format C in a dedicated manner.

Also, the data format converting terminal CS whereby data format conversion processing is to be executed converts data obtained by the data output control terminal 300, and also generates preview data displayable on the portable terminal 100 which is a conceptual image of what will be printed by the printing device PR, of the data obtained by the data output control terminal 300, for each portable terminal 100 model according to the display capabilities thereof (number of lines that can be displayed, display resolution, etc.), and transmits the generated preview data to the data output control terminal 300.

Accordingly, the data output control terminal 300 transmits data obtained from the data format conversion request and WWW server DS to the data format converting terminal CS corresponding to the printing device PR to print data relating to the data printing request, and receives as a response thereto data which can be printed by the printing device PR at which printing is to be carried out, and preview data.

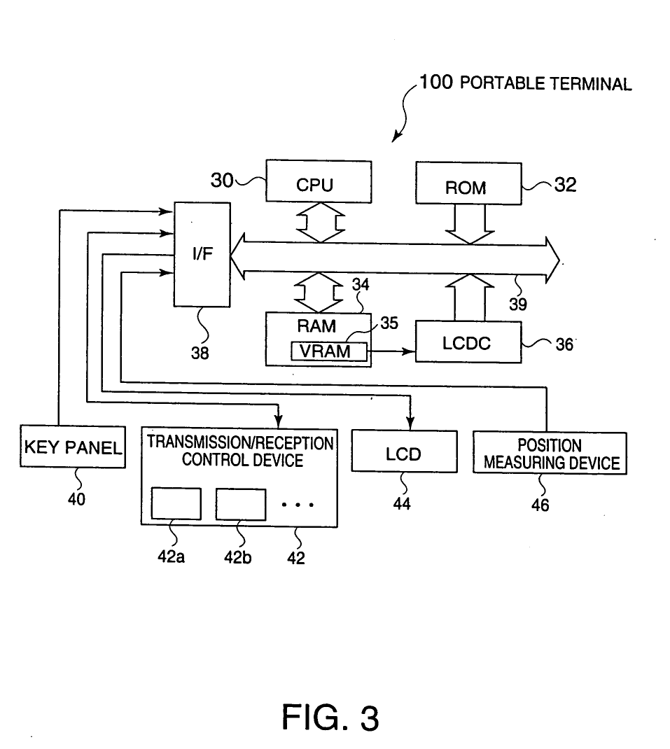

Next, the configuration of the portable terminal 100 will be described with reference to FIG. 3. FIG. 3 is a block diagram illustrating the configuration of the portable terminal 100.

As shown in FIG. 3, the portable terminal 100 is configured of a CPU 30 which controls computations and the entire system based on control programs, ROM 32 storing control programs for the CPU 30 and the like in predetermined areas beforehand, 34 for storing the data read out from the ROM 32 and the like and computation results necessary in the computation processes of the CPU 30, a LCDC (Liquid Crystal Display Controller) 36 for converting data stored in a specified area of the 34 into image signals and outputting to an LCD (Liquid Crystal Display) 44, and an interface 38 serving as a medium for input and output of data from and to external devices. The above elements can be coupled together via a bus 39 which is a signal line for transferring data.

Connected to the interface 38 as external devices are a key panel 40 serving as a human interface whereby data input can be made by multiple keys, a transmission/reception control device 42 for performing wireless communication with base stations 200, an LCD 44 for displaying images based on picture signals, and a position measuring device 46 for measuring the current position.

The transmission/reception control device 42 has multiple communication devices for communicating with the base stations 200 by different communication methods, so as to communicate with base stations 200 by one of the multiple communication devices, and in the event that communication with the base stations 200 fails, communicates with the base stations 200 with another of the multiple communication devices. Two of these communication devices are made up of a long-distance communication device 42a for performing communication with base stations 200 by a long-distance wireless LAN, and a short-distance communication device 42b for performing communication with base stations 200 by a short-distance wireless LAN. Now, only the long-distance communication device 42a and short-distance communication device 42b are shown as communication devices for communicating with the base stations 200 in order to facilitate understanding of the invention, however, it is to be understood other multiple communication devices for performing communication with the base stations 200 by different communication methods may be further connected without departing from the spirit and scope of the present invention.

The ROM 32 stores, in addition to control programs for the CPU 30, verification data for verifying whether or not the user for using the printing service provided by the data output control terminal 300 is a valid user.

The 34 has, as a specified area, V 35 for storing display data for displaying on the LCD 44, with the V 35 being independently accessible to the CPU 30 and the LCDC 36.

The LCDC 36 sequentially reads out the display data stored in the V 35 at a predetermined cycle from the leading address, converts the display data that has been read out into image signals, and outputs to the LCD 44.

The position measuring device 46 can use GPS (Global Positioning System) or the like, and receives time signals from orbit satellites transmitting time signals for the current time, so as to measure the current position based on the offset in time indicated by the times signals and the orbits of the orbit satellites.

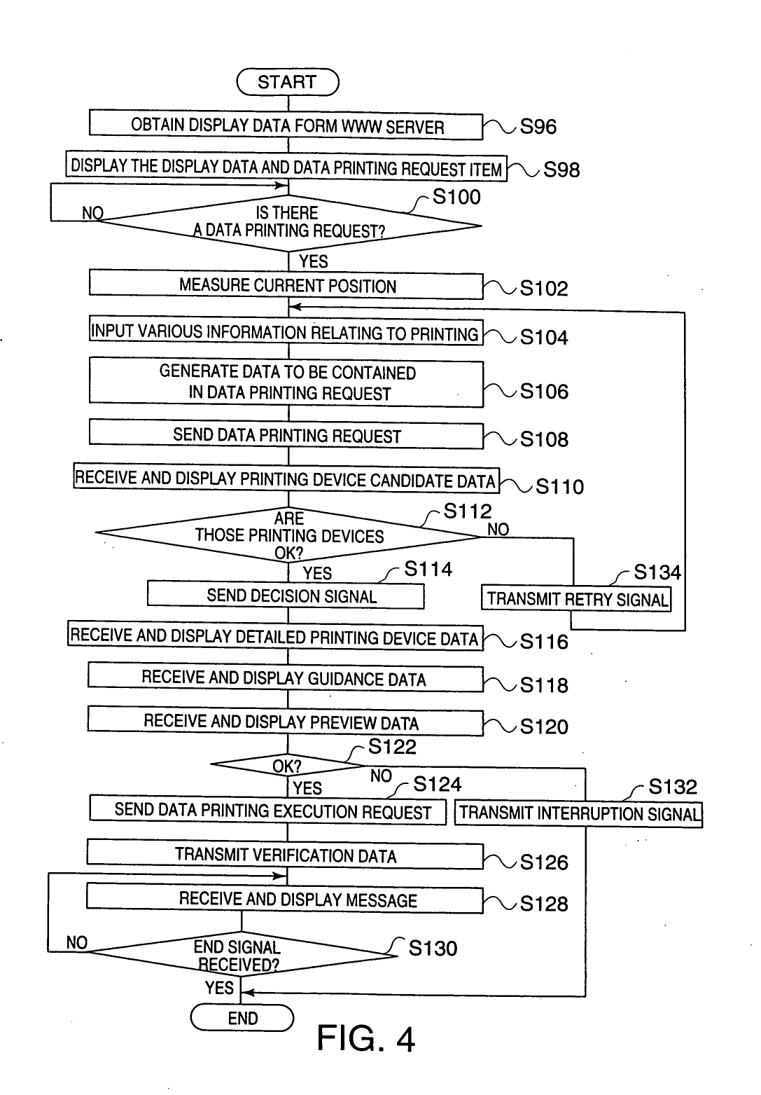

The CPU 30 is made up of a micro-processing unit MPU and the like, for activating predetermined programs stored in predetermined areas of the ROM 32, and executing data printing request processing shown in the flowchart in FIG. 4 following the programs. FIG. 4 is a flowchart illustrating the data printing request processing.

The data printing request processing is processing for requesting printing of data of a WWW server DS specified by the user from one of the printing devices PR₁ through PRₙ, by issuing a data printing request to the data output control terminal 300, and in the event that this is executed at the CPU 30, the flow goes to step S96, as shown in FIG. 4.

In step S96, the WWW server DS specified by the user is accessed and display data is obtained from the WWW server DS, the flow proceeds to step S98, wherein the obtained display data is displayed on the LCD 44 and data printing request items for inputting the printing request for the printing data corresponding to the obtained display data are displayed on the LCD 44 appended to the end of the display data, and the flow proceeds to step S100.

In step S100, a judgment is made regarding whether or not the data printing request item has been selected by input from the user with the key panel 40. In the event that judgment is made that the data printing request item has been selected (Yes), the flow proceeds to step S102 with the understanding that a data printing request has been input, the current position is measured by the position measuring device 46, the flow proceeds to step S104, and various information relating to printing is input from the key panel 40. The user inputs, as this various information relating to printing, for example, a URL which uniquely specifies the position in the Internet 400 of the WWW server DS storing the printing data to be printed, the desired providing area which is a general place where the user desires to be provided with the output data, paper size, whether color or monochrome, printing specifications of the printing device PR such as printing precision or printing speed or the like, the data format of the printing data to be printed, and a printing device ID for identifying a printing device PR in the event of directly specifying a printing device PR. None of these input items are indispensable items, and are selectively input according to the needs of the user. However, in the event that there is no particular specification for the URL of the WWW server DS, the URL of the WWW server DS which the user is currently viewing with the portable terminal 100 can be automatically input.

Next, the flow proceeds to step S106, and data to be contained in the data printing request is generated, based on the various information relating to printing that has been input. That is to say, the data to be contained in the data printing request is generated as portable terminal position data for specifying the position of the current position measured in step S102 as the position of the current position, as printing object storing position data indicating the URL of the WWW server DS, as desired providing area data indicating the desired providing area in the event that the desired providing area has been input, as printing specifications data indicating the printing specifications in the event that printing specifications for the printing device PR have been input, as printing format data indicating the data format in the event that the data format has been input, and as printing device identification data indicating the printing device ID in the event that the printing device ID of a printing device PR has been input.

Next, the flow proceeds to step S108, the data printing request is transmitted from the transmission/reception control device 42 to the data output control terminal 300. The flow proceeds to step S110, printing device candidate data listing candidates for several printing devices PR considered to be optimal for the user to be provided with the output data is received as a response thereof from the data output control terminal 300. The listed printing device PR candidates are displayed on the LCD 44 based on the received printing device candidate data, and the flow proceeds to step S112.

In step S112, a judgment is made regarding whether or not there is a printing device PR from which the user desires to be provided with the data output from the printing device PR candidates displayed on the LCD 44. In the event that judgment has been made that there is a printing device PR from which the user desires to be provided with the data output in the list of the printing device PR candidates displayed on the LCD 44 according to input of a selected one thereof from the key panel 40 (Yes), the flow proceeds to step S114.

In step S114, decision signals indicating that a printing device PR has been decided upon are transmitted to the data output control terminal 300. The flow proceeds to step S116 where printing device information which is detailed information relating to the printing device PR decided upon (the location where the printing device PR is installed, printing specifications, etc.) is received from the data output control terminal 300 as a first response to the decision signal transmission. Detailed information relating to the printing device PR is displayed on the LCD 44 based on the received printing device information, and the flow proceeds to step S118.

In step S118, guidance data indicating guidance information (route information, map information, etc.) for guiding the user from the location of the portable terminal 100 to the location where the printing device PR decided upon is installed is received from the data output control terminal 300 as a second response to transmitting determination signals. The guidance information is displayed on the LCD 44 based on the received guidance data, the flow proceeds to step S120. Where preview data is received from the data output control terminal 300 as a third response to transmitting determination signals. A conceptual image of the printing made by the printing device PR decided upon is displayed on the LCD 44 based on the received preview data, and the flow proceeds to step S122.

In step S122, a judgment is made with the conceptual image displayed on the LCD 44 regarding whether or not the printing data to be printed is correct. In the event that judgment is made that this is correct by the conceptual image displayed on the LCD 44 by inputting a selection from the key panel 40 to the effect that the conceptual image displayed on the LCD 44 is correct (Yes), the flow proceeds to step S124. At this time, in the event that the preview data is made up of multiple sets of data, a desired part of these can be specified in particular for printing.

In step S124, a data printing execution request is sent to the data output control terminal 300. The flow proceeds to step S126 where verification data of the ROM 32 is sent to the data output control terminal 300. The flow proceeds to step S128 where a message is received from the data output control terminal 300 as a response thereto, the received message is displayed on the LCD 44, the flow proceeds to step S130, judgment is made regarding whether or not an end signal indicating that printing of the data has ended has been received from the data output control terminal 300. In the event that judgment is made that an end signal has been received (Yes), the flow of processing ends, but in the event that judgment is made otherwise (No), step S128 is repeated until an end signal is received.

On the other hand, in step S122, in the event that judgment is made that the conceptual image displayed on the LCD 44 is incorrect by the conceptual image displayed on the LCD 44 by inputting a selection from the key panel 40 to the effect that the conceptual image displayed on the LCD 44 is incorrect (No). The flow proceeds to step S132 where interruption signals which are a request to interrupt printing of the data are transmitted to the data output control terminal 300, and the flow of processing ends.

On the other hand, in step S112, in the event that judgment is made that there is no printing device PR from which the user desires to be provided with output of data by inputting a selection from the key panel 40 to the effect that there is no printing device PR which the user desired in the candidates of the printing device PR displayed on the LCD 44 (No), the flow proceeds to step S134 where a retry signal which is a signal for re-searching for printing devices PR considered to be optimal for the user to be provided with the output data is transmitted to the data output control terminal 300, and the flow proceeds to step S104.

On the other hand, in step S100, in the event that judgment is made that no data printing request item is selected (No), this is taken to mean that no data printing request is input, and the flow stands by at step S100 until a data printing request item is selected.

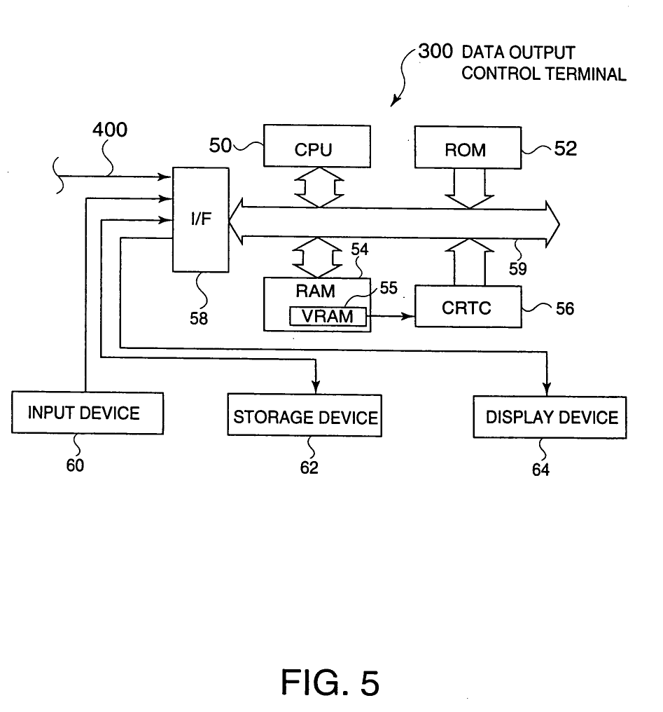

Next, the configuration of the data output control terminal 300 will be described with reference to FIG. 5. FIG. 5 is an exemplary block diagram illustrating the configuration of the data output control terminal 300.

The configuration of the data output control terminal 300 is arranged so as to obtain data relating to the data printing request from the portable terminal 100, select one of the printing devices PR₁ through PRₙ with which to print, and output the obtained data to the selected printing device PR. As shown in FIG. 5, the output control terminal 300 is configured of a CPU 50 which controls computations and the entire system based on control programs, ROM 52 storing control programs or the like in predetermined areas beforehand, 54 for storing the data read out from the ROM 52 and the like and computation results necessary in the computation processes of the CPU 50, a CRTC 56 for converting data stored in a specified area of the 54 into image signals and outputting, and an interface 58 serving as a medium for input and output of data from and to external devices, these elements being coupled together via bus 59 which is a signal line for transferring data.

Connected to the interface 58 as external devices are an input device 60 including a keyboard or mouse or the like serving as a human interface whereby data input can be made, a storage device 62 for storing data and tables and the like as files, a display device 64 for displaying images based on picture signals, and a signal line for connecting to the Internet 400.

The 54 can include, as a specified area, V 55 for storing display data for displaying on the display device 64, with the V 55 being independently accessible to the CPU 50 and the CRTC 56.

The CRTC 56 sequentially reads out the display data stored in the V 55 at a predetermined cycle from the leading address, converts the display data that has been read out into image signals, and outputs to the display device 64.

The storage device 62 stores printing device information relating to printing devices PR necessary for selecting which of the printing devices PR₁ through PRₙ to print the data with. The printing device information for each of the printing devices PR₁ through PRₙ is made up of the following that has been registered: printing device position data for specifying the location where that printing device PR is installed, printing format data indicating the data format which the data format converting terminal CS corresponding to that printing device PR can convert (i.e., data formats which that printing device PR can print), printing specifications data indicating the printing specifications of that printing device PR, and printing device identification data indicating the printing device ID.

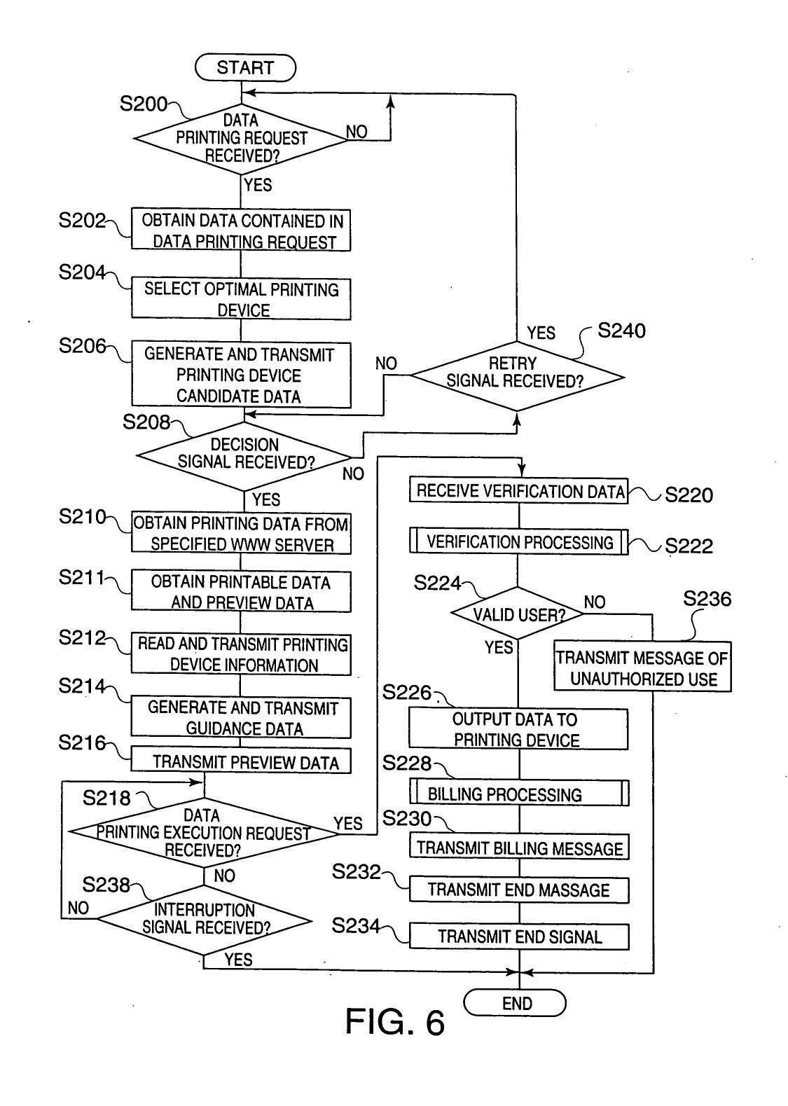

The CPU 50 is made up of a micro-processing unit MPU and the like, for activating predetermined programs stored in predetermined areas of the ROM 52, and executing data output control processing shown in the flowchart in FIG. 6 following the programs. FIG. 6 is a flowchart illustrating the data output control processing.

The data output control processing includes obtaining from the WWW server DS the printing data relating to the data printing request from the portable terminal 100, selecting one of the printing devices PR considered to be optimal for the user of the portable terminal 100 to be provided with the output data, and outputting the obtained printing data to the selected printing device PR, and in the event that this is executed at the CPU 50, the flow first goes to step S200, as shown in FIG. 6.

In step S200, a judgment is made regarding whether or not a data printing request has been received from the portable terminal 100. In the event that judgment is made that a data printing request has been received from the portable terminal 100 (Yes), the flow proceeds to step S202, obtains data obtained in the received data printing request (containing at least portable terminal position data and printing object storing position data). The flow then proceeds to step S204, and selects a printing device PR considered to be optimal for the user of the portable terminal 100 to be provided with the output data.

Specifically, in step S204, the printing device position data of the storage device 62 is searched based on the obtained portable terminal position data, and several printing devices PR considered to be closest distance-wise or time-wise, based on the position of the portable terminal 100, are selected. In the event that desired providing area data is contained in the data printing request, the printing device position data of the storage device 62 is searched based on the desired providing area data, and all printing devices PR in the area specified by the desired providing area data are selected. In the event that printing specifications data is contained in the data printing request, the printing specifications data of the storage device 62 is searched based on the obtained printing specifications data, and all printing devices PR matching that printing specifications data are selected.

Also, in the event that printing format data is contained in the data printing request, the printing format data of the storage device 62 is searched based on the obtained printing format data, and all printing devices PR matching that printing format data are selected. In the event that printing device identification data is contained in the data printing request, the printing device identification data of the storage device 62 is searched based on the obtained printing device identification data, and the printing device PR matching that printing device identification data is selected. In the event that a combination of such data is contained in the data printing request, the selection is narrowed based on each of the data. However, in the event that desired providing area data is contained, but the position specified by the portable terminal position data is not contained in the area specified by the desired providing area data, the selection is not narrowed by the portable terminal position data, and in the event that printing device identification data is contained, the selection is not narrowed by other data.

Next, in step S206, printing device candidate data listing the printing devices PR selected in step S204 is generated, the generated printing device candidate data is transmitted to the portable terminal 100, and the flow proceeds to step S208.

In step S208, a judgment is made regarding whether or not decision signals have been received from the portable terminal 100, and in the event that judgment is made that decision signals have been received (Yes), the flow proceeds to step S210, printing data is obtained from the WWW server DS specified by the URL of the obtained printing object storing position data. The flow then proceeds to step S211 where the obtained printing data is transmitted to a data format converting terminal CS capable of converting the printing data and corresponding to the printing device PR which has been decided upon, data which can be printed by the printing device PR decided upon and preview data is obtained from the data format converting terminal CS as a response thereto, and the flow proceeds to step S212.

In step S212, printing device information regarding the printing device PR decided upon is read out from the storing device 62, the read printing device information is transmitted to the portable terminal 100. The flow proceeds to step S214, guidance data regarding the printing device PR decided upon is generated, the generated guidance data is transmitted to the portable terminal 100, the flow proceeds to step S216, the preview data is transmitted to the portable terminal 100, and the flow proceeds to step S218.

In step S218, a judgment is made regarding whether or not a data printing execution request has been received from the portable terminal 100. In the event that judgment is made that a data printing request has been received (Yes), the flow proceeds to step S220 and receives verification data from the portable terminal 100. The flow then proceeds to step S222 where verification processing is executed based on the received verification data for verifying whether or not the user of the portable terminal 100 is a valid user for using the printing service provided by the data output control terminal 300, and the flow proceeds to step S224.

In step S224, a judgment is made regarding whether or not the user of the portable terminal 100 is a valid user as a result of the verification processing performed in step S222. In the event that judgment is made that the user is a valid user (Yes), the flow proceeds to step S226 where the data which can be printed at the printing device PR decided upon is transmitted to that printing device PR. The flow then proceeds to step S228 and billing processing for performing billing according to the results of use of the printing service provided by the data output control terminal 300 by the portable terminal 100 is executed.

In this step S228, specifically, the telephone bill of the portable terminal 100 (e.g., telephone bill per minute) is calculated, the service usage fees according to the usage results of the portable terminal 100 are calculated making reference to a fee calculating stipulation table defining the service usage fees as prices of the printing services provided for, e.g., the amount of printing data obtained, the number of sheets printed with the printing device PR, and the printing specifications of the printing device PR, as usage results of the portable terminal 100, the calculated service usage fees are added to the telephone bill, and the added total amount is stored as an invoice amount for the user of the portable terminal 100.

Next, the flow proceeds to step S230, a billing message indicating the service usage fees calculated by the billing processing in step S228 is transmitted to the portable terminal 100. The flow then proceeds to step S232 where an end message to the effect that printing of data has ended is transmitted to the portable terminal 100. The flow proceeds to step S234 where an end signal is transmitted to the portable terminal 100, and the flow of processing ends.

On the other hand, in the event that judgment is made in step S224 that the user of the portable terminal 100 is not a valid user (No), the flow proceeds to step S236, a message to the effect that the user is an invalid user is transmitted to the portable terminal 100, and the flow of processing ends.

On the other hand, in the event that a judgment is made in step S218 that a data printing execution request has not been received from the portable terminal 100 (No), the flow proceeds to step S238 where a judgment is made regarding whether or not an interruption signal has been received from the portable terminal 100. In the event that a judgment is made that an interruption signal has been received (Yes), the flow of processing ends, but in the event that judgment is made otherwise (No), the flow proceeds to step S218.

On the other hand, in the event that judgment is made in step S208 that a determining signal has not been received from the portable terminal 100 (No), the flow proceeds to step S240 where a judgment is made regarding whether or not a retry signal has been received from the portable terminal 100. In the event that judgment is made that a retry signal has been received (Yes) the flow proceeds to step S200, but in the event that judgment is made otherwise (No), the flow proceeds to step S208.

On the other hand, in the event that judgment is made in step S200 that a data printing request has not been received from the portable terminal 100 (No), the flow stands by in step S200 until a data printing request is received.

Next, the operation of the above embodiment will be described.

First, in the event that a valid user for using the printing services provided by the data output control terminal 300 operates the portable terminal 100 which he/she has, and accesses for example, a WWW server DS₁, display data is obtained from the WWW server DS₁ through the steps S96 and 98, the obtained display data is displayed on the LCD 44, and also data printing request items are appended to the end of the display data and displayed on the LCD 44. Description will be made regarding the example of a case wherein the user is to print detailed data of the data displayed on the LCD 44.

In order for the user to print the object data, first, the data printing request item displayed on the LCD 44 is selected by input from the key panel 40.

Once the data printing request item is selected, the current position is measured at the portable terminal 100 by the CPU 30 with the position measuring device 46, through steps S100 and S102, and input requests for various information relating to the printing are displayed on the LCD 44. Now, if the user inputs by specifying the URL of the WWW server DS₁ of the various information relating to the printing currently being viewed, portable terminal position data and printing object storing position data are generated as data to be contained in the data printing request, based on the input various information relating to printing, through the steps S104 through S108, and the data printing request is transmitted to the data output control terminal 300.

Though transmission of the data printing request to the data output control terminal 300 is performed by the transmission/reception control device 42, specifically, one communication device of the multiple communication devices of the transmission/reception control device 42 communicates with base stations 200. In the event that communication using this communication device fails due to change in the communication state or the like, communication is made with base stations 200 using another communication device of the multiple communication devices of the transmission/reception control device 42. At this time, in the event that the long-distance communication device 42a or the short-distance communication device 42b has been selected as the communication device, communication is made with the base stations 200 by long-distance wireless LAN or short-distance wireless LAN.

At the data output control terminal 300, upon receiving the data printing request, the CPU 50 obtains data contained in the received data printing request (the portable terminal position data and printing object storing position data) through the steps S200 through S204, the printing device position data of the storing device 62 is searched based on the obtained portable terminal position data, and several printing devices PR considered to be the closest distance-wise or time-wise with the position of the portable terminal 100 as a reference, are selected. At this time, saying that printing devices PR₁ through PR₅ are selected, printing device candidate data listing the printing devices PR₁ through PR₅ is generated through step S206, and the generated printing device candidate data is transmitted to the portable terminal 100.

At the portable terminal 100, upon receiving the printing device candidate data, the listed printing devices PR₁ through PR₅ are displayed on the LCD 44 based on the received printing device candidate data, through step S110. Now, in the event that the user inputs selection of the printing device PR₁ from the key panel 40, decision signals indicating that the printing device PR₁ has been decided upon are transmitted to the data output control terminal 300, through the steps S112 and S114.

At the data output control terminal 300, upon receiving the decision signals, printing data from the WWW server DS, specified by the URL of the obtained printing object storing position data is obtained through the steps S208 through S211, the obtained printing data is transmitted to a data format converting terminal CS capable of converting the printing data and corresponding to the printing device PR₁ decided upon (e.g., the data format converting terminal CS₁), and data capable of being printed at the printing device PR₁ decided upon and preview data are obtained from the data format converting terminal CS₁ as a response thereto. Then, in steps S212 through 216, printing device information regarding the printing device PR₁ decided upon is read out from the storing device 62, the read printing device information is transmitted to the portable terminal 100, guidance data regarding the printing device PR₁ decided upon is generated, the generated guidance data is transmitted to the portable terminal 100, and preview data is transmitted to the portable terminal 100.

At the portable terminal 100, upon receiving the printing device information, guidance data, and preview data, the detailed information relating to the printing device PR is displayed on the LCD 44 based on the received printing device information, guidance information from the location of the portable terminal 100 to the location where the printing device PR₁ is installed is displayed on the LCD 44 based on the received guidance data, and a conceptual image of the printing performed by the printing device PR₁ decided upon is displayed on the LCD 44 based on the received preview data, by the steps S116 through S120. Now, in the event that user inputs from the key panel 40 a selection to the effect that the conceptual image displayed on the LCD 44 is correct as the printing data to be printed, the data printing execution request and verification data of the ROM 32 are transmitted to the data output control terminal 300 through the steps S122 through 126. At this time, in the event that the preview data is made up of multiple sets of data, the user can specify portions thereof to be printed in particular (trimming). In the event that trimming is performed, the data printing execution request containing the request for printing the specified portion is transmitted to the data output control terminal 300.

At the data output control terminal 300, upon receiving the data printing execution request and the verification data, verification processing is executed thought the steps S218 through S222 based on the received verification data. Here, the user is a valid user for using the printing service provided by the data output control terminal 300, so the data which can be printed by the printing device PR₁ decided upon is transmitted to the printing device PR₁ through the steps S224 through S234. At this time, in the event that a request for printing a specified part is contained in the data printing execution request, the specified part of the data capable of being printed with the printing device PR₁ is transmitted to the printing device PR₁. Then, billing processing is executed, and the billing message, end message, and end signal are transmitted to the portable terminal 100.

At the portable terminal 100, upon receiving the billing message, end message, and end signal, the billing message and end message are displayed on the LCD 44 through steps S128 and S130 being repeated. On the other hand, at the printing device PR₁, upon receiving data capable of being printed with the printing device PR₁, printing is performed based on the received data.

Following display of the end message, the user goes to the shop S₁ where the printing device PR₁ is installed, looking at the guidance information displayed on the LCD 44, and receives the data printed by the printing device PR₁. The service usage fees as the price of the printing services provided is added to the telephone bill of the portable terminal 100 and invoiced.

Conversely, the service provider can receive the price of providing the service by adding the service usage fees as the price of the printing services provided to the telephone bill and invoicing the user.

Now, in the event that the user enters for the various information relating to printing, a desired providing area which is a general area where the user desires to be provided with the output data, desired providing area data indicating the desired providing area is transmitted to the data output control terminal 300, at the data output control terminal 300 the printing device position data of the storage device 62 is searched based on the obtained desired providing area data, and all the printing devices PR in the area specified by the desired providing area data are selected.

For example, in the event that the user inputs “Shibuya” as the desired providing area, all the printing devices PR installed around Shibuya are displayed on the LCD 44 of the portable terminal 100.

Also, in the event that the user enters for the various information relating to printing, printing specifications for the printing device PR, printing specifications data indicating the printing specifications is transmitted to the data output control terminal 300, and at the data output control terminal 300, the printing specifications data of the storage device 62 is searched based on the obtained printing specifications data, and all the printing devices PR matching the printing specifications data are selected.

For example, in the event that the user inputs “Color” as the printing specifications, all the printing devices PR capable of printing data in color are displayed on the LCD 44 of the portable terminal 100.

Also, in the event that the user enters for the various information relating to printing, data format, printing format data indicating the data format is transmitted to the data output control terminal 300, and at the data output control terminal 300, the printing format data of the storage device 62 is searched based on the obtained printing format data, and all the printing devices PR matching the printing format data are selected.

For example, in the event that the user inputs “HTML” as the data format, all the printing devices PR corresponding to data format converting terminals CS capable of converting HTML format data are displayed on the LCD 44 of the portable terminal 100.

Also, in the event that the user enters for the various information relating to printing, the printing device ID of the printing device PR for directly specifying the printing device PR, printing device identification data indicating that printing device ID is transmitted to the data output control terminal 300, and at the data output control terminal 300, the printing device identification data of the storage device 62 is searched based on the obtained printing device identification data, and the printing device PR matching the printing device identification data is selected.

For example, in the event that the user inputs “0001” as the printing device ID, the printing device PR with the printing device ID “0001” is displayed on the LCD 44 of the portable terminal 100. In the event that no printing device PR with a printing device ID “0001” exists, no printing device PR is displayed at all.

Also, in the event that the user enters for the various information relating to printing, a combination of desired printing area, printing specifications, and data format, data indicating each is transmitted to the data output control terminal 300, and at the data output control terminal 300, the selection is narrowed down based on the multiple sets of obtained data, and all the matching printing devices PR are selected.

For example, in the event that the user inputs “Shibuya”, “Color”, “HTML” as the desired printing area, printing specifications, and data format, all the printing devices PR corresponding to data format converting terminals CS capable of converting HTML format data that are situated around Shibuya and are capable of printing the data in color are displayed on the LCD 44 of the portable terminal 100.

Also, in the event that the user is not a valid user for using the printing service provided by the data output control terminal 300, at the time that the conceptual image is displayed on the LCD 44, inputting from the key panel 40 a selection to the effect that the conceptual image displayed on the LCD 44 is correct as the printing data to be printed does not result in the printing device PR, printing the object data.

Thus, with the present embodiment, the portable terminal 100 obtains data from the WWW server DS, displays the obtained data on the LCD 44 and also data printing request items are appended to the end of the display data and displayed on the LCD 44. In the event that a displayed data printing request item is selected, a data printing request is sent to the data output control terminal 300.

Accordingly, detailed information of the display data displayed on the LCD 44 is printed with the printing device PR, so detailed information corresponding to the simplified information on the Internet 400 which the user is viewing with the portable terminal 100 can be more readily obtained than in conventional arrangements, and particularly, data is printed merely by selecting the data printing request item appended to the display data, so data can be printed relatively easily. Accordingly, the service provider can provide information services with high satisfaction to users.

Further, with the present embodiment, the portable terminal 100 includes a transmission/reception control device 42 having multiple communication devices for performing communication with the data output control terminal 300 by different communication methods. Further, in the event that a data printing request is sent to the data output control terminal 300 by one of the multiple communication devices and communication with the data output control terminal 300 fails, a data printing request is sent to the data output control terminal 300 by another of the multiple communication devices.

Accordingly, even in an environment wherein the communication state changes dynamically, as with a portable terminal 100 which performs communication while moving, communication with base stations 200 can be established in a relatively certain manner. Accordingly, service providers can provide a comfortable communication environment to the user regardless of the communication state of the portable terminal 100.

Further, with the present embodiment, the portable terminal 100 has a long-distance wireless LAN and a short-distance wireless LAN as communication devices.

Accordingly, data printing can be performed relatively easily, without the task of connecting a network cable. Thus, the service provider can provide even more satisfying information services to the user.

Further, with the present embodiment, in the event that the conceptual image data displayed on the LCD 44 is made up of multiple sets of data, and specification is input for a part thereof regarding which printing is desired, the portable terminal 100 sends a data printing execution request containing a request for printing the specified part to the data output control terminal 300. Thus, the user can obtain from the detailed information on the Internet 400, only the information that is necessary. Accordingly, the service provider can provide even more satisfying information services to the user.

Further, with the present embodiment, the data output control terminal 300 selects a printing device PR from the multiple printing devices PR, considered to be optimal for the user of the portable terminal 100 to be provided with the output data. Thus, the user can receive the output data more readily, and can obtain detailed information on the Internet 400 even more readily. Accordingly, the service provider can provide even more satisfying information services to the user.

Further, with the present embodiment, the data output control terminal 300 searches for printing device position data of the storage device 62 based on the portable terminal position data contained in the data printing request, and selects a printing device PR considered to be the closest distance-wise or time-wise with the position of the portable terminal 100 as a reference.

Accordingly, data relating to the data printing request is printed at a printing device PR considered to be the closest distance-wise or time-wise with the position of the portable terminal 100 as a reference, so the user can receive the output data even more readily, and can obtain detailed information on the Internet 400 even more readily. Accordingly, the service provider can provide even more satisfying information services to the user.

Further, with the present embodiment, the data output control terminal 300 searches for printing device position data of the storage device 62 based on the desired providing area data contained in the data printing request, and selects printing devices PR in the area specified by the desired providing area data.

Accordingly, data relating to the data printing request is printed at a printing device PR in the desired providing area which is a general location where the user desires to be provided with the output data, so the user can receive the output data according to their object, and thus can receive detailed information on the Internet 400 even more readily. Accordingly, the service provider can provide even more satisfying information services to the user.

Further, with the present embodiment, the data output control terminal 300 does not search for portable terminal position data in the event that a position specified by portable terminal position data does not exist in the area specified by the desired providing area data contained in the data printing request.

Accordingly, in the event that the user inputs a desired providing area, priority is given to searching with the desired providing area data over searching with the portable terminal position data, and data relating to the data printing request is printed at a printing device PR in the desired providing area, so the user can receive the output data with priority given to their object, and thus can receive detailed information on the Internet 400 even more readily. Accordingly, the service provider can provide even more satisfying information services to the user.

Further, with the present embodiment, the data output control terminal 300 searches for printing format data of the storage device 62 based on the printing format data contained in the data printing request, and selects printing devices PR matching the printing format data.

Accordingly, data relating to the data printing request is printed at a printing device PR capable of printing with the data format specified by the user, so the user can receive the output data according to their object, and thus can receive detailed information on the Internet 400 even more readily. Accordingly, the service provider can provide even more satisfying information services to the user.

Further, with the present embodiment, the data output control terminal 300 searches for printing specifications data of the storage device 62 based on the printing specifications data contained in the data printing request, and selects printing devices PR matching the printing specifications data.

Accordingly, data relating to the data printing request is printed at a printing device PR capable of printing with the printing specifications specified by the user, so the user can receive the output data according to their object, and thus can receive detailed information on the Internet 400 even more readily. Accordingly, the service provider can provide even more satisfying information services to the user.

Further, with the present embodiment, the data output control terminal 300 searches for printing device identification data of the storage device 62 based on only the printing device identification data contained in the data printing request, and selects the printing device PR matching the printing device identification data.

Accordingly, data relating to the data printing request is printed at the printing device PR uniquely specified by the user, so the user can receive the output data according to their object, and thus can receive detailed information on the Internet 400 even more readily. Accordingly, the service provider can provide even more satisfying information services to the user.

Further, with the present embodiment, the data output control terminal 300 outputs printing device information corresponding to the selected printing device PR to the portable terminal 100. Accordingly, notifying the user of information relating to the printing device PR which will provide the output data can prevent the user from mistakenly printing data. Accordingly, the service provider can provide even more satisfying information services to the user.

Further, with the present embodiment, the data output control terminal 300 obtains data relating to the data printing request from a WWW server DS. Accordingly, at the time of printing detailed information, printing data and data printable at the printing device PR is processed by the data output control terminal 300, so increased memory for the portable terminal 100 is unnecessary, and the load placed on the portable terminal 100 is reduced. Also, there is no need to read the data into the portable terminal 100, so the communication time is reduced, and the amount of time required to receive the output data is reduced. Accordingly, the service provider can provide printing services for a comfortable printing environment to the user, regardless of the functions of the portable terminal 100.

Further, with the present embodiment, the data output control terminal 300 selects one of the multiple printing devices PR based on portable terminal position data for specifying the position of the portable terminal 100.

Accordingly, data is printed at a printing device PR in a positional relation with the portable terminal 100, so, for example, selecting a printing device PR considered to be the closest distance-wise or time-wise with the position of the portable terminal 100 as a reference would allow the user to receive the output data even more readily, and obtain detailed information on the Internet 400 even more readily. Accordingly, the service provider can provide even more satisfying information services to the user.

Further, with the present embodiment, the data output control terminal 300 obtains data from a WWW server DS specified by a URL contained in the data printing request.

Thus, detailed information can be obtained from all the WWW servers DS connected to the Internet 400. Accordingly, the service provider can provide even more satisfying information services to the user.

Further, with the present embodiment, the data output control terminal 300 obtains printing data from a WWW server DS as data relating to the data printing request.

Thus, general information is displayed on the portable terminal 100 and detailed information is printed at the printing device PR, so detailed information on the Internet 400 can be obtained with the portable terminal 100, while realizing comfortable display processing. Accordingly, the service provider can provide even more satisfying information services to the user, and can provide a more comfortable printing environment and printing services to the user.

Further, with the present embodiment, the data output control terminal 300 transmits preview data generated with a data format converting terminal CS to the portable terminal 100, and upon receiving a data printing execution request from the portable terminal 100 as a response to the output of the preview data, outputs data relating to the data printing request to the printing device PR.

Thus, preview data is notified to the user before providing the output data, thereby preventing the user from mistakenly printing out data. Accordingly, the service provider can provide even more satisfying information services to the user.

Further, with the present embodiment, the data output control terminal 300 performs billing according to the results of the use by the portable terminal 100 of printing services provided by the data output control terminal 300.

Thus, the service usage fees can be clearly calculated as the price of printing service provided, and also service usage feeds do not have to be calculated each time the user receives a printing service. Accordingly, the service provider can readily handle office routine for settling service fees and further clarify service usage fees for the user, and thus provide even more satisfying information services to the user.

Further, with the present embodiment, the service usage fees as the price of printing service provided is added to the telephone bill.

Accordingly, payment of the service usage fees is easier for the user, and the service provider can collect service usage fees easily and securely and can further easily handle office routine for settling service usage fees.

Further, with the present embodiment, the data output control terminal 300 outputs data converted with the data format converting terminal CS to the printing device PR.

Thus, even in the event that a new printing device PR is installed, it is only necessary to change the settings of the data format converting terminal CS regarding that new printing device PR at the service provider side, and the user can use the new printing device PR without making any changes in the settings at the user side. Accordingly, setting work which accompanies installing new printing devices PR is made easy for service providers, which further provides even more satisfying information services to the user.

Further, with the present embodiment, the data output control terminal 300 transmits guidance data indicating guidance information, for guiding the user from the position of the portable terminal 100 to the position where the printing device PR which has been decided upon is installed, to the portable terminal 100.

Thus, the user can follow the guidance information and go to the position where the printing device PR is installed, and thus can obtain the output data in a relatively sure manner. Accordingly, the service provider can provide even more satisfying information services to the user.

Further, with the present embodiment, the data format converting terminals CS₁ through CSₙ select one or a plurality of the data format converting terminals CS₁ through CSₙ according to the sending load of the Internet 400 or the processing load of a data format converting terminal CS, so as to execute data format conversion processing with the selected data format converting terminal CS.

Accordingly, data format conversion processing is executed with data format converting terminals CS with a small sending load of the Internet 400 or the processing load, so the time required to receive the output data becomes approximately constant, regardless of the sending load of the Internet 400 or the processing load of the data format converting terminal CS. Accordingly, the service provider can provide printing services for a more comfortable printing environment to the user.

Also, in the above embodiment, the portable terminal 100 is configured so as to display data obtained from a WWW server DS on the LCD 44 and also append a data printing request item at the end of the display data and then display this on the LCD 44, and in the event that the displayed data printing request item is selected, to send a data printing request to the data output control terminal 300, but is not restricted to this, and may be configured so as to display data obtained from a WWW server DS on the LCD 44 and also display a data printing request item as a separate menu item from the display data on the LCD 44, and in the event that the displayed data printing request item is selected, to send a data printing request to the data output control terminal 300.

Thus, data printing is carried out simply by selecting the data printing request item displayed as a menu item, so data printing can be performed relatively easily. Accordingly, the service provider can provide highly satisfying information services to the user.

Also, in the above embodiment, the portable terminal 100 is configured so as to display data obtained from a WWW server DS on the LCD 44 and also append a data printing request item at the end of the display data and then display this on the LCD 44, and in the event that the displayed data printing request item is selected, to send a data printing request to the data output control terminal 300, but is not restricted to this, and may be configured with an input button for inputting data printing requests as a part of the key panel 40, wherein, in the event that the input button is pressed, a data printing request is sent to the data output control terminal 300.

Thus, data printing is carried out simply be pressing the input button, so data printing can be performed relatively easily. Accordingly, the service provider can provide highly satisfying information services to the user.

Also, in the above embodiment, data printing requests contain portable terminal position data, printing object storing position data, desired providing area data, printing specifications data, printing format data, and printing device identification data, but the present invention is not restricted to this, and may contain only printing object storing position data.

Thus, even portable terminals having only the functions of simply displaying data obtained from a WWW server DS on the LCD 44, the printing service can be used. Accordingly the service provider can provide printing services to the user, regardless of the functions of the portable terminal.

Also, with the above embodiment, the data output control terminal 300 is configured so as to search printing device position data of the storage device 62 based on portable terminal position data generated at the portable terminal 100, but the present invention is not restricted to this, and may be configured so as to generate portable terminal position data based on position data relating to the position of the portable terminal 100 from base stations 200 to which the portable terminal 100 is connected, and search printing device position data of the storage device 62 based on the generated portable terminal position data. The same advantages as those of the above embodiment can be obtained even with such a configuration.

Also, with the above embodiment, the portable terminal 100 is configured so as to measure the current position with the position measuring device 46, and generate portable terminal position data based on the measured position, but the present invention is not restricted to this, and may be configured so as to obtain position data relating to the position of the portable terminal 100 from base stations 200 to which the portable terminal 100 is connected, and generate portable terminal position data based on the obtained position data. The same advantages as those of the above embodiment can be obtained even with such a configuration.

Also, with the above embodiment, a printing device PR which is considered to be the closest distance-wise or time-wise with the position of the portable terminal 100 as a reference, a printing device PR in an area specified by desired providing area data, a printing device PR matching printing format data, a printing device PR matching printing specifications data, or a printing device PR matching printing device identification data is selected as a printing device PR considered to be optimal for the user of the portable terminal 100 to receive output data, but the present invention is not restricted to this, and further, the configuration may be such that, for example, a printing device PR which is considered to be able to provide the user with the output data the earliest, taking into consideration the data output speed of the printing device PR, or a printing device PR of the most inexpensive price for providing the output data, is selected.

According to the former configuration, data relating to the data printing request is printed at a printing device PR which is considered to be able to provide the user with the output data the earliest, so the user can receive output data meeting his/her object, and can obtain detailed information on the Internet 400 even more readily. Accordingly, the service provider can provide even more satisfying information services to the user.

According to the latter configuration, data relating to the data printing request is printed at a printing device PR of the most inexpensive price for providing the output data, so the user can receive output data meeting his-her object, and can obtain detailed information on the Internet 400 even more readily. Accordingly, the service provider can provide even more satisfying information services to the user.

Also, the above embodiment is configured such that printing devices PR₁ through PRₙ for printing data are provided, and data relating to data printing requests from a portable terminal 100 is printed at one of the printing devices PR, but the present invention is not restricted to this, an a configuration may be made wherein, for example, an output device for displaying data or for outputting data as audio is provided, and data relating to the data output request from the portable terminal 100 is output at one of the output devices.

Also, the above embodiment is configured so as to generate preview data with a data format converting terminal CS, but the present invention is not restricted to this, and may be configured so as to generate preview data at the data output control terminal 300.

Also, the above embodiment is configured such that the data format converting terminals CS₁ through CS₁ select one or a plurality of the data format converting terminals CS₁ through CS₁ according to the sending load of the Internet 400 or the processing load of a data format converting terminal CS, so as to execute data format conversion processing with the selected data format converting terminal CS, but the present invention is not restricted to this, and may be configured so as to execute data format conversion processing with a specified data format converting terminal.

Also, the above embodiment is configured so as to execute the processing shown in the flowcharts in FIG. 4 and FIG. 6 with a specified data output control terminal 300, but the present invention is not restricted to this, and a configuration may be made wherein, as seen with the data format converting terminals CS₁ through CS₁, multiple data output control terminals are provided. Further, one of the multiple data output control terminals can be selected according to the sending load of the Internet 400 or the processing load of the data output control terminals, and carried out with the selected data output control terminal.

According to such a configuration, the processing shown in the flowcharts in FIG. 4 and FIG. 6 is executed with a data output control terminal with a small sending load of the Internet 400 or the processing load, so the time required to receive the output data becomes approximately constant, regardless of the sending load of the Internet 400 or the processing load of the data output control terminal. Accordingly, the service provider can provide printing services as a more comfortable printing environment to the user.

Also, the above embodiment has been described with regard to a case of applying the portable terminal and data output control system according to the present invention to the Internet 400. However, it is to be understood that the present invention is not restricted to this, and as a matter of course can be applied to networks other than the Internet 400.

Also, the above embodiment has been described with regard to an arrangement wherein the portable terminal 100, data format converting terminals CS₁ through CS₁, WWW servers DS₁ through DSₘ, printing devices PR₁ through PRₙ, and data output control terminal 300 are connected via the same network. However, it is to be understood that the present invention is not restricted to this, and an arrangement may be made wherein the data output control terminal 300 and the portable terminal 100, the data output control terminal 300 and the data format converting terminals CS₁ through CS₁, the data output control terminal 300 and the WWW servers DS₁ through DSₘ, and the data output control terminal 300 and the printing devices PR₁ through PRₙ, are each connected via different networks.

Also, the above embodiment has been described with regard to an arrangement wherein the processing shown in the flowcharts in FIG. 4 and FIG. 6 is executed by executing control programs stored beforehand in the ROMs 32 and 52. However, it is to be understood that the present invention is not restricted to this, and may read programs from a storage medium storing programs indicating these procedures into the RAMs 34 and 54, to execute.

Now, a storage medium can be a semiconductor storage medium such as RAM or ROM, a magnetic storage type storage medium such as an FD or HD, an optical reading type storage medium such as a CD, CDV, LD, or DVD, or a magnetic storage type/optical reading type storage medium such as an MO, and contains all the storage media as long as the storage medium is computer-readable, regardless of the reading method, whether electric, magnetic, optic, or so forth.

Also, with the above embodiment, the portable terminal and data output control system according to the present invention are applied to a case of providing a service wherein, as shown in FIG. 2, a service provider obtains data relating to data printing requests from one of WWW servers DS₁ through DSₘ according to the data printing requests from a user, with a data output control device 300, and outputs to one of printing devices PR₁ through PRₙ. However, it is to be understood that the present invention is not restricted to this, and is applicable to other cases without departing from the essence of the present invention.

1. A portable terminal that communicates with a data output control device, the portable terminal being a user-owned portable terminal which is portable and sends output requests for data, the data output control device being coupled to the portable terminal, a plurality of output terminals situated at various locations for outputting data, and a data storing terminal storing data, via a network, said data output control device comprising:
an obtaining device that obtains data relating to said data output requests from said user-owned portable terminal;
a selecting device that selects one of said plurality of output terminals; and
an output device that outputs data obtained by said obtaining device to an output terminal selected by said selecting device,
wherein the data output control device is coupled with a data format conversion device that performs data format conversion, the data format conversion device being a different device from the portable terminal,
wherein said portable terminal further comprises a terminal-side obtaining device that obtains data from said data storing terminal, a display device that displays data obtained by said terminal-side obtaining device, an input device that inputs output requests for data displayed by said display device, and data output request originating device that sends data output requests input by said input device to said data output control device.

2. The portable terminal according to claim 1,
wherein input items for prompting input to said input device are displayed on said display device along with data obtained by said terminal-side obtaining device,
and wherein said data output request originating device sends output requests for data displayed by said display device to said data output control device, in the event that said input items are selected as input by said input device.

3. The portable terminal according to claim 1,
wherein input items for prompting input to said input device are displayed on said display device as menu items separate from said data obtained by said terminal-side obtaining device,
and wherein said data output request originating device sends output requests for data displayed by said display device to said data output control device, in the event that said input items are selected as input by said input device.

4. The portable terminal according to claim 1,
wherein the input device is an input button.

5. A portable terminal which uses a data output control device, the portable terminal being a user-owned portable terminal which is portable and sends output requests for data, the data output control device communicably connects to the portable terminal and a plurality of output terminals situated at various locations for outputting data, via a network, said data output control device comprising:
a selecting device that selects one of said plurality of output terminals; and
an output device that outputs data relating to said data output request to an output terminal selected by said selecting device,
wherein the data output control device is coupled with a data format conversion device that performs data format conversion, the data format conversion device being a different device from the portable terminal,
wherein said portable terminal further comprises a plurality of communicating devices that perform communication with said data output control device with different communication methods, communication path selecting device that selects from said plurality of communicating devices a communicating device which is currently communicable with said data output control device, and data output request originating device that sends said data output requests to said data output control device with the communication device selected by said communication path selecting device.

6. The portable terminal according to claim 5,
wherein said communication path selecting device and said data output request originating device send said data output request to said data output control device by one of said plurality of communication devices, and in the event that communication with said data output control device fails, send said data output request to said data output control device by another of said plurality of communication devices.

7. The portable terminal according to claim 5, further comprising at least one of a long-distance wireless LAN (Local-Area Network) and a short-distance wireless LAN as said communication devices.

8. A data output control system, including a user-owned portable terminal which is portable and sends output requests for data, and a data output control device which receives data output requests from said portable terminal and performs output control of data relating to the data output requests;
said data output control device communicably connecting said portable terminal, a plurality of output terminals situated at various locations for outputting data, and a data storing terminal storing data, via a network;
wherein said data output control device comprises, an obtaining device that obtains data relating to said data output requests from said data storing terminal, a selecting device that selects one of said plurality of output terminals, and an output device that outputs data obtained by said obtaining device to an output terminal selected by said selecting device;
wherein the data output control device is coupled with a data format conversion device that performs data format conversion, the data format conversion device being a different device from the portable terminal,
and further wherein said portable terminal comprises a terminal-side obtaining device that obtains data from said data storing terminal, a display device that displays data obtained by said terminal-side obtaining device, an input device that inputs output requests for data displayed by said display device, and data output request originating device that sends data output requests input by said input device to said data output control device.

9. The data output control system according to claim 8,
wherein said portable terminal displays input items for prompting input to said input device on said display device along with data obtained by said terminal-side obtaining device;
and wherein said data output request originating device sends output requests for data displayed by said display device to said data output control device, in the event that said input items are selected as input by said input device.

10. The data output control system according to claim 8,
wherein said portable terminal displays input items for prompting input to said input device on said display device as menu items separate from said data obtained by said terminal-side obtaining device;
and wherein said data output request originating device sends output requests for data displayed by said display device to said data output control device, in the event that said input items are selected as input by said input device.

11. The data output control system according to claim 8,
wherein the input device is an input button.

12. A data output control system including a user-owned portable terminal which is portable and sends output requests for data, and a data output control device which receives data output requests from said portable terminal and performs output control of data relating to the data output requests;
said data output control device communicably connecting said portable terminal and a plurality of output terminals situated at various locations for outputting data, via a network;
said data output control device comprising a selecting device that selects one of said plurality of output terminals, and an output device that outputs data relating to said data output request to an output terminal selected by said selecting device;
wherein the data output control device is coupled with a data format conversion device that performs data format conversion, the data format conversion device being a different device from the portable terminal,
wherein said portable terminal comprises a plurality of communicating devices that perform communication with said data output control device with different communication methods, a communication path selecting device that selects from said plurality of communicating devices a communicating device which is currently communicable with said data output control device, and data output request originating device that sends said data output requests to said data output control device with the communication device selected by said communication path selecting device.

13. A data output control system according to claim 12,
wherein said communication path selecting device and said data output request originating device send said data output request to said data output control device by one of said plurality of communication devices, and in the event that communication with said data output control device fails, send said data output request to said data output control device by another of said plurality of communication devices.

14. A data output control system according to claim 12, said portable terminal further comprising at least one of a long-distance wireless LAN (Local-Area Network) and a short-distance wireless LAN as said communication devices.

15. The portable terminal according to claim 1, wherein, when requesting data output by an output terminal, data transmitted from the portable terminal is an output request only.

16. The portable terminal according to claim 5, wherein, when requested data output by an output terminal, data transmitted from the portable terminal is an output request only.

17. The data output control system according to claim 8, wherein, when requested data output by an output terminal, data transmitted from the portable terminal is an output request only.

18. The data output control system according to claim 12, wherein, when requested data output by an output terminal, data transmitted from the portable terminal is an output request only.

19. The portable terminal according to claim 1, wherein the data format conversion device performs conversion to a data format that is outputable by an output terminal, and performs conversion to a data format that is displayable by the portable terminal.

20. The portable terminal according to claim 5, wherein the data format conversion device performs conversion to a data format that is outputable by an output terminal, and performs conversion to a data format that is displayable by the portable terminal.

21. The data output control system according to claim 8, wherein the data format conversion device performs conversion to a data format that is outputable by an output terminal, and performs conversion to a data format that is displayable by the portable terminal.

22. The data output control system according to claim 12, wherein the data format conversion device performs conversion to a data format that is outputable by an output terminal, and performs conversion to a data format that is displayable by the portable terminal.

23. An output terminal that uses a data output control device, the data output control device being coupled to a user-owned portable terminal which is portable and sends output requests for data, the output terminal for outputting data, and a data storing terminal storing data, via a network, said data output control device comprising:
an obtaining device that obtains data relating to said data output requests from said user-owned portable terminal;
a selecting device that selects one of said plurality of output terminals; and
an output device that outputs data obtained by said obtaining device to an output terminal selected by said selecting device,
wherein the data output control device is coupled with a data format conversion device that performs data format conversion, the data format conversion device being a different device from the portable terminal,
wherein said portable terminal further comprises, a terminal-side obtaining device that obtains data from said data storing terminal, a display device that displays data obtained by said terminal-side obtaining device, an input device that inputs output requests for data displayed by said display device, and data output request originating device that sends data output requests input by said input device to said data output control device.

24. The portable terminal according to claim 23,
wherein input items for prompting input to said input device are displayed on said display device along with data obtained by said terminal-side obtaining device,
and wherein said data output request originating device sends output requests for data displayed by said display device to said data output control device, in the event that said input items are selected as input by said input device.

25. The portable terminal according to claim 23,
wherein input items for prompting input to said input device are displayed on said display device as menu items separate from said data obtained by said terminal-side obtaining device,
and wherein said data output request originating device sends output requests for data displayed by said display device to said data output control device, in the event that said input items are selected as input by said input device.

26. The portable terminal according to claim 23,
wherein the input device is an input button.

27. The output terminal according to claim 23, wherein, when requested data output by an output terminal, data transmitted from the portable terminal is an output request only.

28. The output terminal according to claim 23, wherein the output terminal being a printing device having a printer section.

29. The output terminal according to claim 28, wherein the printing device receives data in a predetermined data format and exclusively prints the data in the predetermined data format.
